(19) United States
(12) Patent Application Publication
(10) Pub. No.: US 2016/0343072 A1
(43) Pub. Date: Nov. 24, 2016

(54) METHOD AND SYSTEM FOR BUSINESS CUSTOMER ON-BOARDING

(71) Applicant: Manish Mohnot, Wilmington, DE (US)

(72) Inventor: Manish Mohnot, Wilmington, DE (US)

(21) Appl. No.: 15/161,804

(22) Filed: May 23, 2016

Related U.S. Application Data
(60) Provisional application No. 62/165,482, filed on May 22, 2015.

(51) Int. Cl. G06Q 40/02; G06Q 10/06

(52) U.S. Cl. CPC G06Q 40/02; G06Q 10/063112

(57) ABSTRACT

The business customer onboarding process enables banks or financial services providers to meet business customer's needs. A user interface is employed to guide a customer or financial advisor through a step-by-step process in collecting relevant information, whereby only relevant information pertaining to the customer's need is collected. The user interface provides multi-lingual supports which is customizable by the customer. Windows of the user interface for information collection are determined based on the customer's need and information gathered in immediately preceding windows. This collected data is then utilized complete the application for one or more bank services. The onboarding process enables an omni-channel lead capture for sales to the customer.

### PRIORITY

This application claims priority to U.S. Provisional Application 62/165,482, filed May 22, 2015, which is hereby incorporated by reference as if submitted in its entirety.

### FIELD OF THE INVENTION

The present invention relates to business customer onboarding, and, more particularly, a method and system that streamline data collection thereby improving productivity and reducing cost of business customer acquisition for lenders.

### BACKGROUND OF THE INVENTION

Credit Availability for Businesses in US has been drying for many years. There are three key reasons: 1) high death rate for small businesses drives higher credit risk and thereby higher scrutiny in credit underwriting, 2) cost of acquiring business customers are high due to relatively fewer customers who put more premium on winning their business, and 3) absence of conformity in available information in order to streamline lending processes.

Newer or smaller Businesses have high teething issues and thus are more prone to early closure. This phenomenon makes them more (credit) risky for lenders. Coupled with a high cost of acquisition, this makes the segment less attractive to lenders. This reflects in the continual drop in small loans (less than $150,000 USD) made by financial institutions. This challenge has been a focus for alternate lenders, who often make most loans in $5,000-$30,000 USD and at 15%-30% annual interest rates.

Larger/mature businesses have typically weathered initial teething issues and usually have larger capital needs (purchasing larger equipment, buildings usually are more costly/premium, larger working capital etc), usually in the range of $150,000 USD to $1 MM. Lenders find these larger businesses more attractive from credit risk perspective. However, generally, these businesses demand attractive interest rates and fees, thereby making them less profitable (even though less risky) for lenders. In addition, the high cost of acquisition makes this segment less profitable to lenders

### SUMMARY OF THE INVENTION

A method for performing business customer onboarding, comprising: identifying a need of a business customer; matching a business expert with said customer; assessing said need of said customer; displaying a series of windows to request information related to said customer, wherein said information is used to create at least one application to fulfill said need; and verifying said at least one application. Said information is also used to create a second application to fulfill a second need. The method further comprises offering non-bank related transactions.

### BRIEF DESCRIPTION OF THE DRAWINGS

This disclosure is illustrated by way of example and not by way of limitation in the accompanying figure(s). The figure(s) may, alone or in combination, illustrate one or more embodiments of the disclosure. Elements illustrated in the figure(s) are not necessarily drawn to scale. Reference labels may be repeated among the figures to indicate corresponding or analogous elements.

FIG. 1 illustrates an aspect of an exemplary embodiment of the present invention;

FIG. 2 illustrates an aspect of an exemplary embodiment of the present invention;

FIG. 3 is an exemplary process flow of the present invention;

FIG. 4 is an exemplary configuration of the present invention;

FIG. 5 is an exemplary screenshot of the present invention;

FIG. 6 is an exemplary screenshot of the present invention;

FIG. 7 is an exemplary screenshot of the present invention;

FIG. 8 is an exemplary screenshot of the present invention;

FIG. 9 is an exemplary screenshot of the present invention;

FIG. 10 is an exemplary screenshot of the present invention;

FIG. 11 is an exemplary screenshot of the present invention;

FIG. 12 is an exemplary screenshot of the present invention;

FIG. 13 is an exemplary screenshot of the present invention;

FIG. 14 is an exemplary screenshot of the present invention;

FIG. 15 is an exemplary screenshot of the present invention;

FIG. 16 is an exemplary screenshot of the present invention;

FIG. 17 is an exemplary screenshot of the present invention;

FIG. 18 is an exemplary screenshot of the present invention;

FIG. 19 is an exemplary screenshot of the present invention;

FIG. 20 is an exemplary screenshot of the present invention;

FIG. 21 is an exemplary screenshot of the present invention; and

FIG. 22 is an exemplary screenshot of the present invention.

### DETAILED DESCRIPTION

While the concepts of the present disclosure are susceptible to various modifications and alternative forms, specific embodiments thereof are shown by way of example in the drawings and are described in detail below. It should be understood that there is no intent to limit the concepts of the present disclosure to the particular forms disclosed. On the contrary, the intent is to cover all modifications, equivalents, and alternatives consistent with the present disclosure and the appended claims.

Computer-implemented platforms, engines, systems and methods of use are disclosed that provide networked access to a plurality of types of digital content, including but not limited to video, audio, metadata, interactive and document content, and that track, deliver manipulate, transform and report the accessed content. Described embodiments of these platforms, engines, systems and methods are intended to be exemplary and not limiting. As such, it is contemplated that the herein described systems and methods can be adapted to provide many types of cloud-based valuations, scoring, marketplaces, and the like, and can be extended to provide enhancements and/or additions to the exemplary platforms, engines, systems and methods described. The invention is thus intended to include all such extensions. Reference will now be made in detail to various exemplary and illustrative embodiments of the present invention.

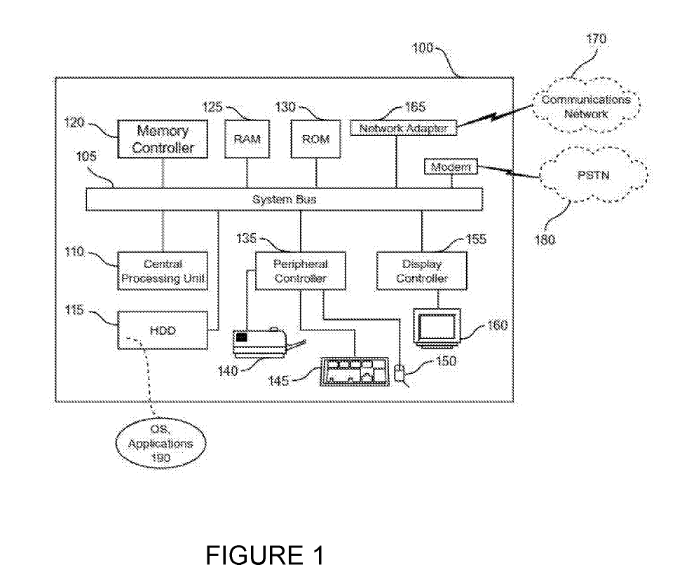

FIG. 1 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

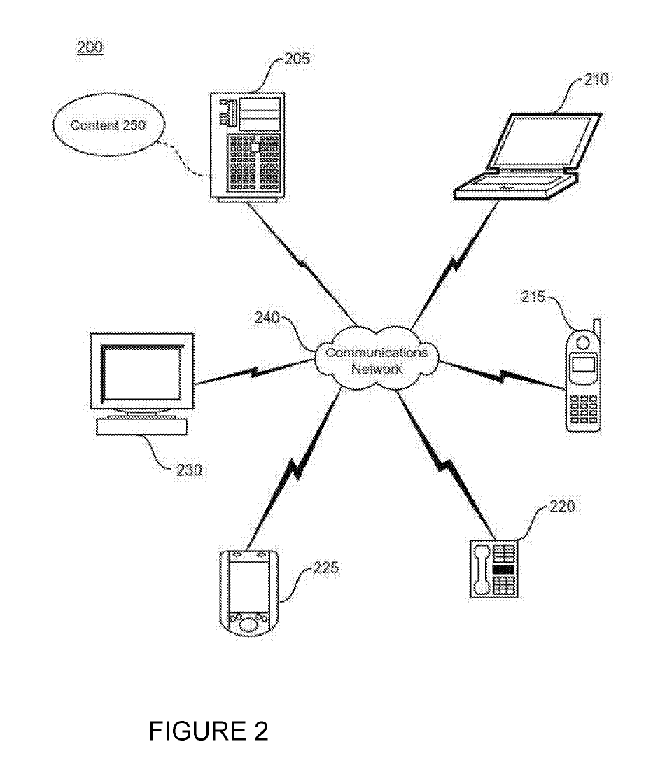

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

Absence of generally accepted sales/originations, infrastructure increases the cost of business transaction originations.
Bureaus: While information on 99% of Adult US Credit Consumers can be found in credit bureaus, information on only 60-70% of businesses can be found in credit bureaus.
Data collection tools: Since bureaus do not have full information, information is collected from business owners on each request. Businesses are generally very heterogenic which increases the customization of each credit request. This causes the information needed to underwrite each loan to be different.

Currently, there is no standardization or tools on the market, thus sales and data collection is done completely by a manual process. Exacerbating the failings of prior techniques are different ownership structures (i.e., not for profit, solo proprietors, partnerships, corporate ownerships, etc.) which are asked for different financial documents to underwrite loans, varied financing needs (i.e., equipment financing, building mortgage, working capital, merchant processing credit risk, etc.) which demand different documentation that shows value of collaterals, and segment specific needs (for example: service industries have fewer/weaker collaterals when compared to manufacturing industries; Doctor offices have strong receivables and goodwill but little to no collateral).

In addition to the high cost of business customer acquisition, most business (aka commercial) sales teams with banks or financial services providers focus on certain (limited) product set and lose sight of the overall customer relationship. In other words, all banking products are not sold to businesses. Most business bankers focus on credit for businesses, most branch bankers' focus on checking accounts. Products like cash management, merchant services, business credit cards, etc., are not cross-sold to Business Owners frequently, thereby negatively impacting profitability of the business customer acquisitions.

Together, a streamlining process of taking applications (i.e., collecting information for underwriting purposes) & effectively cross-selling will increase profitability from business customers and will make them attractive segments for banks, credit unions, or other financial service providers.

The present invention enables banks or other similar financial services providers to meet a customer's needs. For exemplary purposes, the customer may be a business customer. The aforementioned needs may be met via a myriad of channels including, but not limited to, online, bank branches, at a customer's premise, via telephone, or the like. With respect to a startup, example needs would include, but not be limited to, business checking and wires or the like; payment needs of ACH, POS box, merchant gateway, mobile card readers, or the like; funds to run an existing business (i.e., working capital, expenses, marketing needs, etc.); and growth/investment needs (i.e. purchasing/constructing a building, purchasing equipment/vehicles, acquiring another business, and expanding to other locations, etc.). The needs could possibly be initiated by business owners themselves or an advisor to the business owner (i.e., CPA, Attorney, Broker, Equipment Seller, Franchisor, Bank or other financial/lending institution, etc.). Requests may be made from any capable display format including, but not limited to, desktop PC, laptop, tablet, or a mobile phone, or the like. It is intended that the system GUI would adjust to the format and platform being used, such as through the use of a normalization or multi-code engine, or based upon a platform-sensing redirection, such as to secondary or tertiary servers. The display format also preferably provides, on all platforms and devices, different language support enabling multilingual capabilities.

Once a request is made, a GUI is displayed providing a step-by-step guide in collecting relevant information. The relevant information may be provided, for example, by the aforementioned business owner or somebody working on behalf of the business owner (i.e. a financial advisor). It is the goal of the step-by-step process to only collect relevant information, as determined by the specific financial institution, for each business and business need. Resulting is a full relationship between a business customer and a financial entity, whereby multiple products may be utilized by a business customer utilizing a single application process, at least in that multiple offerings of the institution, and/or from other institutions/partners, may be automatically analyzed, whether or not part of the customer's request, for best and/or eligible matches to the customer's profile.

More specifically, based on the application process, a “Point of sale” response is enabled wherein on spot recommendations or counter offers may be made for the business customers. The recommendations or counter offers ensure that a customer is increasingly to always gets something by way of an offer/counteroffer. For example, if a business customer needs checking, savings, and a line of credit, and a first bank only offers checking and savings (such as because the first bank does not offer lines of credit, or because the customer does not meet the first bank's criteria for lines of credit per the customer's profile), the first bank may recommend a second bank that provides the line of credit. If there isn't a second bank, the marketplace can be explored for other lenders and/or offers available. This exploration is done in real-time so that the customer can be offered products to ensure that the customer's needs are met. In another embodiment, if the business customer does not possess any business credit, the customer can use a personal line of credit to secure products offered.

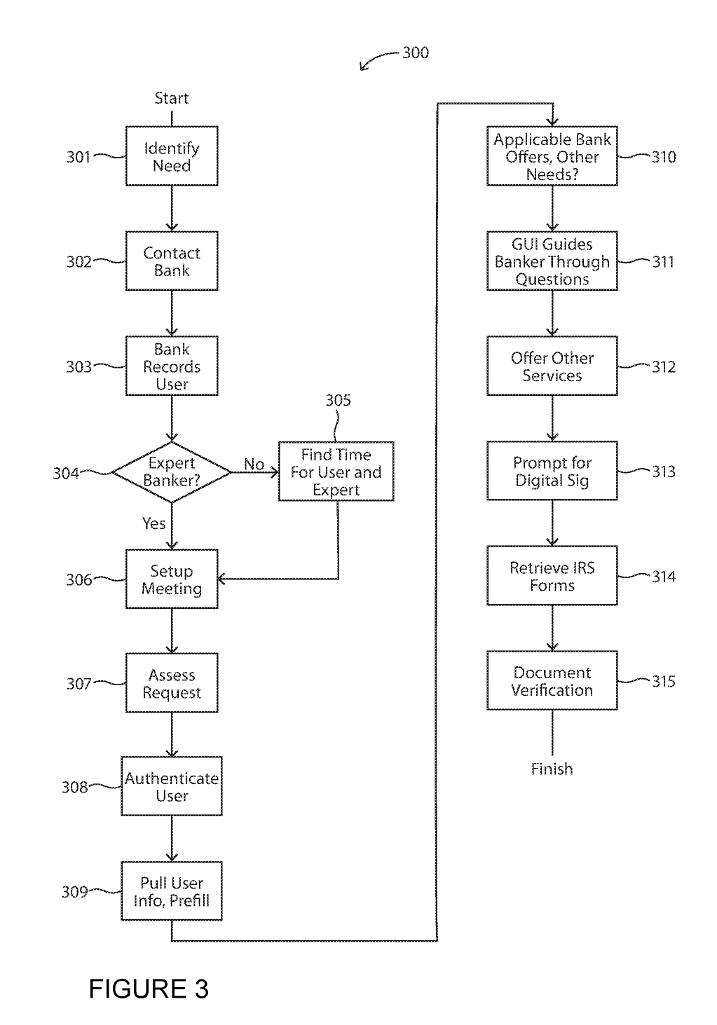

An example process flow 300 is shown in FIG. 3. In step 301, a need is identified. A business owner (or advisor) may identify the need for the business owner to start new or expand an existing relationship with a bank or financial services provider. These needs include, but are not limited to: business checking account and checks, setup Wires or Letter of Credits for making payments to suppliers, Payment acceptance (i.e. ACH, POS box, merchant gateway, Mobile card readers, etc.), Funds to run an existing business (i.e., working capital, expenses, marketing needs, etc.), funds to grow an existing business (i.e. purchase/lease building to house existing business, refinance, construction/renovation, equipment purchase, company vehicles, expansions, etc.), investment funds (i.e., building purchase for rental/resell), and funds for business acquisition (i.e., buying out partner, etc.). In step 302, the business owner is put in contact with a bank. Contact may be made by any practical means (i.e., phone, internet, direct/personal contact, etc.). In an alternative embodiment, a combination of self-serve and assisted service for the business customer may be used. In step 303, an initial contact person takes basic information (business name, owner's name, contact info) of the business customer, what kind of business (aka industry classification), and the requested need that the bank is being asked to serve. Moving to step 304, if the initial contact person is an expert banker and can serve further, the process moves to step 306. If the initial contact person is not an expert banker, the process moves to step 305 and a time is found where an expert banker is available before moving to step 306. All of the information collected is recorded in the system. Further, the information collected is in the language suitable for the bank/Customer. This enables the bank to take and record leads for further follow-up opportunities. This enables multi-channel/omni-channel lead capture for sales to a business customer. The multi-lingual capabilities make this system useful for various geographies. While lead recording does exist at most banks, these are generally used for consumer side.

Often 2-3 sales people make contacts with the business owner, at which point, the bank settles on the final expert sales staff that is going to further serve the customer. In this process, invaluable time is lost for the business owner, in addition to expenses associated with routing. Additionally, invariably, the business owner is left with a less than smooth/positive impression. The proposed system identifies the right expert sales person to best serve the business customer. The identification is based upon the needs of the business customer. For example, amount of funds requested, the customer's region, and other factors dependent upon the bank. The overall system is configurable for each bank/financial institution. This identification system allows for the routing of a lead from originator to final sales staff.

Moving on to step 306, the system sets up appointments between expert sales staff, sales person (if applicable), and the business customer entity. Next steps are determined and communicated to all parties involved. The system identifies sales staff for the bank based on sales staff directory and business rules for the bank. Additionally, the system interacts with calendars to setup appointments based on availability. In step 307, the business customer's request is assessed. The assessment consists of a meeting between the expert and the business customer. The expert discusses the project/need and seeks quick information on legal structure and partnership structure of the company. Also requested is a business ID (i.e. Tax ID in the U.S., other similar IDs in other countries), and primary owner's bureau ID (i.e., SSN in U.S.). These two IDs are then used in step 308 to reduce fraud. Step 308 authenticates the business information from appropriate bureaus against information provided by the business customer. Credit characteristics of the business owner and the business itself can be pulled in real time to guide the conversation. Based on the bank's rules, the system may prompt the expert sales staff for further information. Every bank has minimum credit thresholds for each product (i.e., loans/lines). Counteroffers include but are not limited to: smaller funds amount for loan/line/letter of credit, alternate collateral (i.e., line backed by customer's payment using POS/Payment gateways instead of backed by cash receivables, alternate guarantees (i.e., counter offer can be made for loan with SBA guarantees), and alternate product offer. For the alternate product offer, if the customer's line backed by customer's payments is not offered by the expert's bank, the system can offer a product offered by the system's independent's provider. This choice can be configured by the bank. If the customer's credit characteristics are below the bank's thresholds and no counter offers could be made available, the expert sales staff is notified immediately. The bank can still offer non-credit products and continue to build a relationship for those products. If the customer's credit characteristics meet or exceed the threshold, the expert sales staff is prompted immediately and the stage is set for further conversations. This does not signify a commitment to lend, but merely a high probability to lend. If the business customer is looking for products that are not impacted by credit, the system can continue to offer those products. If the system identifies fraud, a further verification would be required by the system. The system can also be enabled to prompt the expert sales staff for some of the business needs that the bank is capable of serving. These prompts will be based on previous history/experiences based on the platform. This allows an increase in the wallet share of customer with the bank. In step 309, the system pre-fills the application based on the retrieved credit information. In step 310, applicable bank offers and other needs are identified.

Moving to step 311, the expert sales staff is guided by the system through a series of GUI windows for relevant questions that should be asked dependent upon the identified needs and products sought. For example, if the customer is purchasing a building, the system asks whether the property is owner occupied or an investment property. Different banks have different rules for down-payment needs for each kind of property. If the customer cannot make a down payment needed by the bank, the system, on behalf of the bank, can make a counter offer with SBA loan guarantee. The system asks relevant and pertinent questions for each need of the customer and reacts with every answer to narrow down offers that will suit the customer's need. The system, at the same time, also narrows down next set of questions that should be asked. Using these questions and answers format, the system continues to narrow down offers to meet the customer's needs. Once an offer is narrowed down, the system can share the product offer, rates, fees, and the set expectations with the Customer. The banks can configure the system to show what they want to share. Moving to step 312, the system makes other financial services products that a bank may not offer. For example, a bank may not offer POS box itself, but it may be able to offer that product to its Customers via this platform through a different bank. In step 313, once the application is complete, the customer can digitally sign the application. This may be done via the device itself (i.e., tablet, mobile device). The digital signature allows the bank to make an official request for 4506-t for the business and business owner's from the IRS (step 314). The system, in at least one alternative embodiment, enables the uploading of further documents as indicated by a list created by the system. Some documents can be digitally signed on the screen of the device in use. The signature would allow a bank to pull the customer's info from other sources (like tax transcripts for the business and business owners from the IRS). Additionally, the system seeks personal financials in a private manner such that each business owner can see their own and blocked from seeing other's personal financials. The system is further enabled to allow customers to make payments as agreed by them and the bank for the services rendered. Example payment methods include, but are not limited to, checking account and credit cards. The system also captures account information where proceeds for loan or line or payment processing (like POS box) are expected.

In step 315, the system ensures that all information and documentation is complete before sending for further action by the back office. More signatures may be required. The back office can download all of the information either manually or via an automatic feed to their underwriting/boarding systems for prompt action.

All of these customer steps could be done in one meeting between customer and bank's sales staff. The system enables real time processing and information gathering from other sources (like bureaus, IRS, etc.). This saves time for business owner and effort/cost for the bank. The system allows for more customers to be served by bank and each customer can be served for more needs than they would otherwise be.

Each bank's policies are different and they have to setup on the system to enable the above process. Banks have management consoles to setup these rules and change them when desired. Each change needs an approval from bank's authorities to ensure setup is according to the policies.

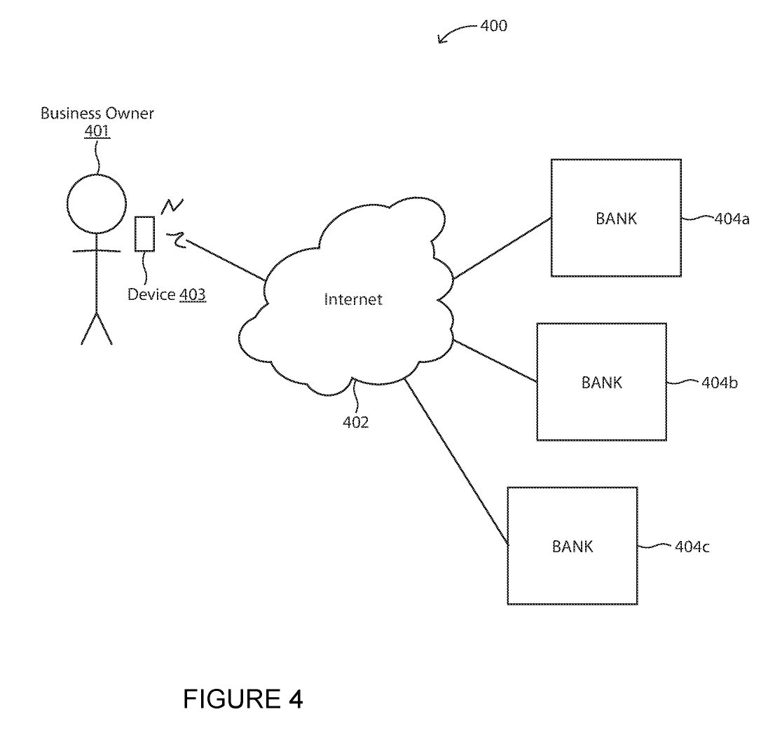

An example configuration 400 is shown in FIG. 4. User 401 (i.e., business owner or financial advisor working on behalf of business owner) accesses the software platform GUI via device 403. The software platform GUI connects to one or more banks (404a, 404b, 404n . . . ) or financial institutions via network (i.e., Internet) 402. Device 403 is not meant to be limiting. While the device can be any type of smartphone device (i.e. iPhone, Windows Mobile, or Android, etc.) the device is meant to include other devices which comprise a screen. For example, a PC, tablet, laptop, or other type of computing device as is known in the art. The platform GUI may employ specific logic utilized to display a series of user interfaces based on the information needed to complete an application.

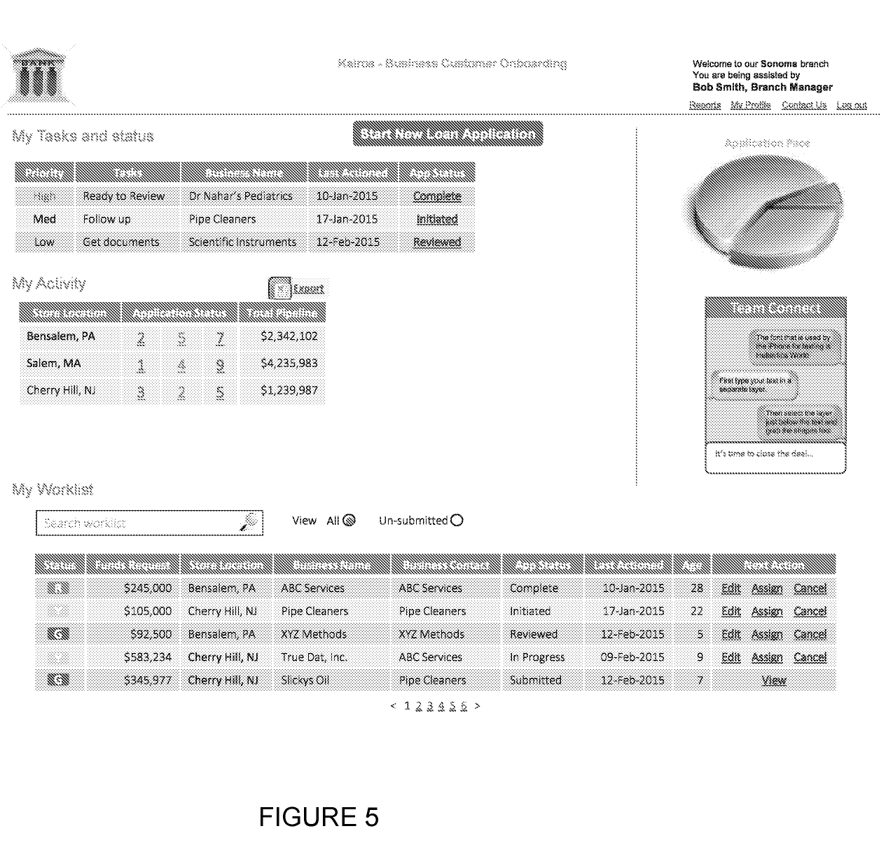

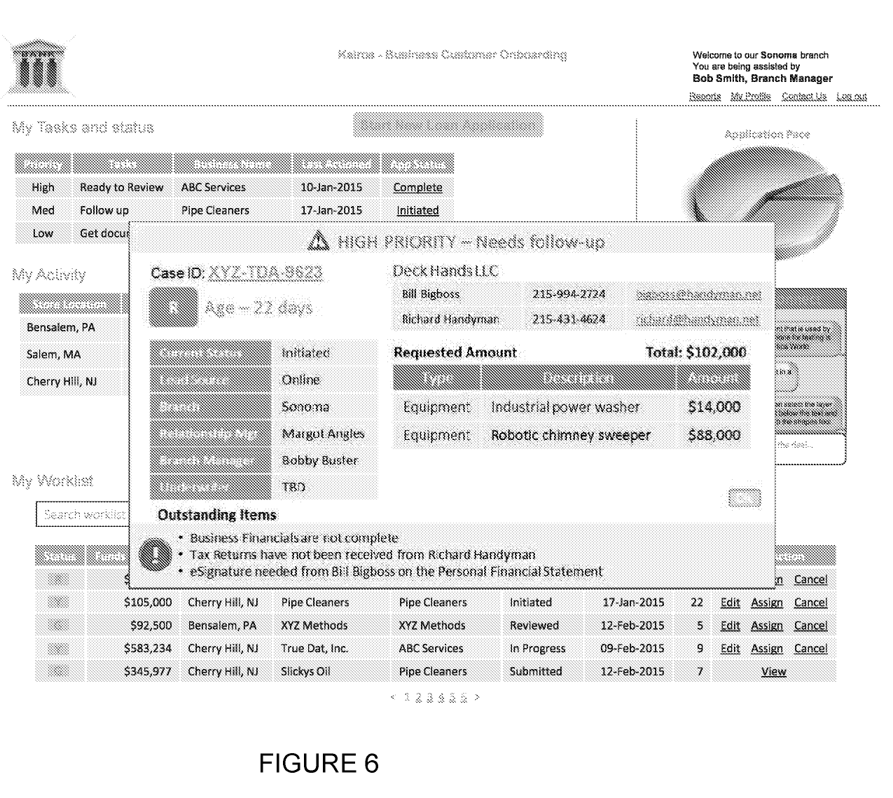

FIGS. 5 and 6 are exemplary screenshots of the business customer onboarding application. FIG. 5 shows a business customer given the opportunity to start a new loan application, view tasks and/or status of current loan applications, recent activity, and a current worklist. FIG. 6 shows an exemplary screenshot of the business customer being prompted with information that requires immediate attention.

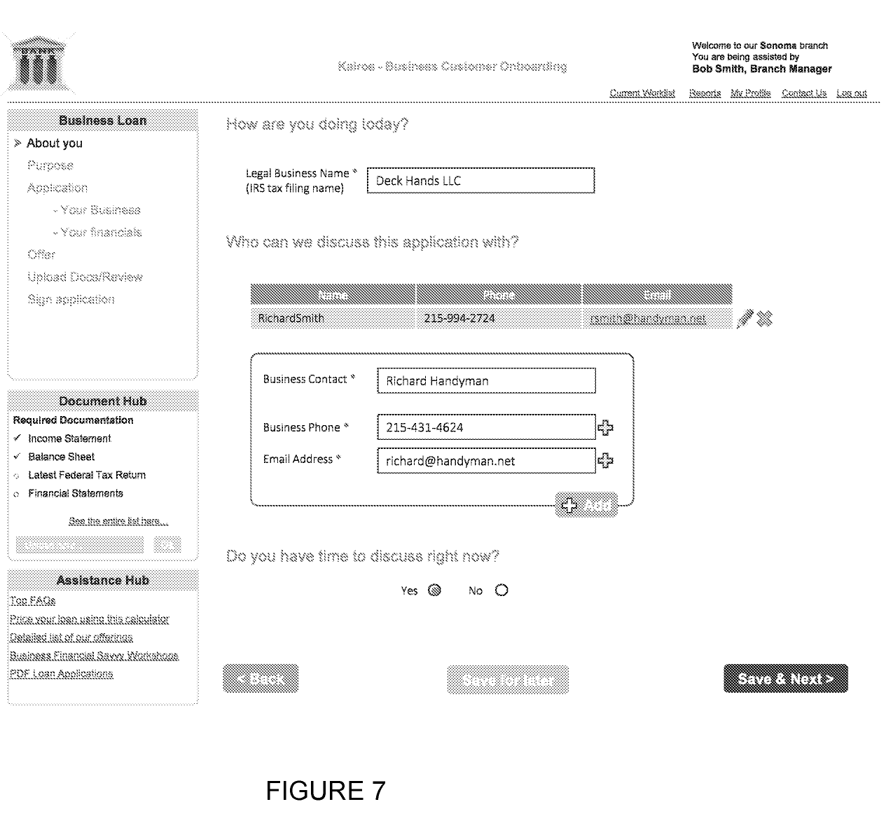

FIG. 7 is an exemplary screenshot of the business customer onboarding application. A business customer may be provided with fields to enter appropriate information to being the business loan application process. The information may include, but is not limited to, the business name, contact name, contact phone number, and e-mail address, among other information that may be collected. At any point in time, the business customer may save the application for later and resume at another point in time, for example from the screenshot of FIG. 5.

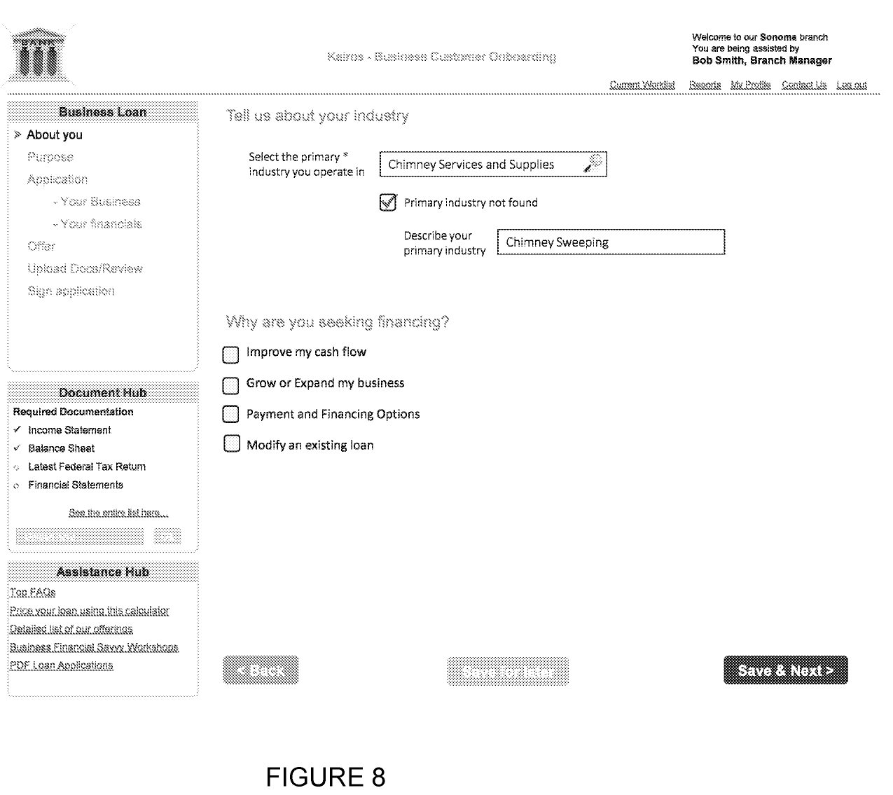

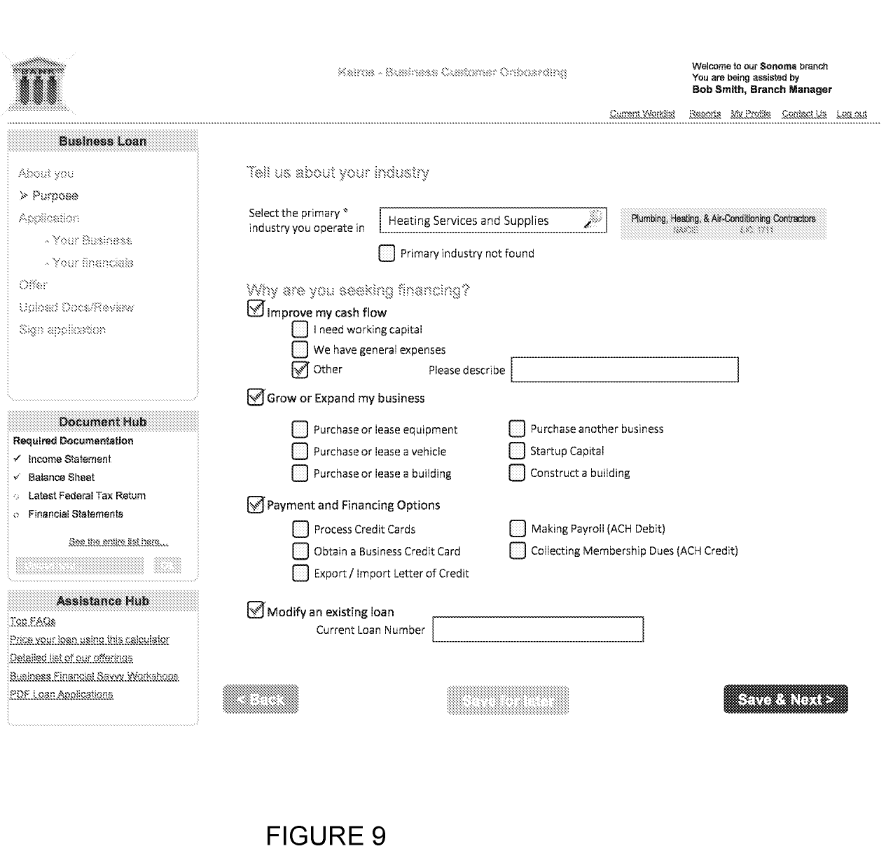

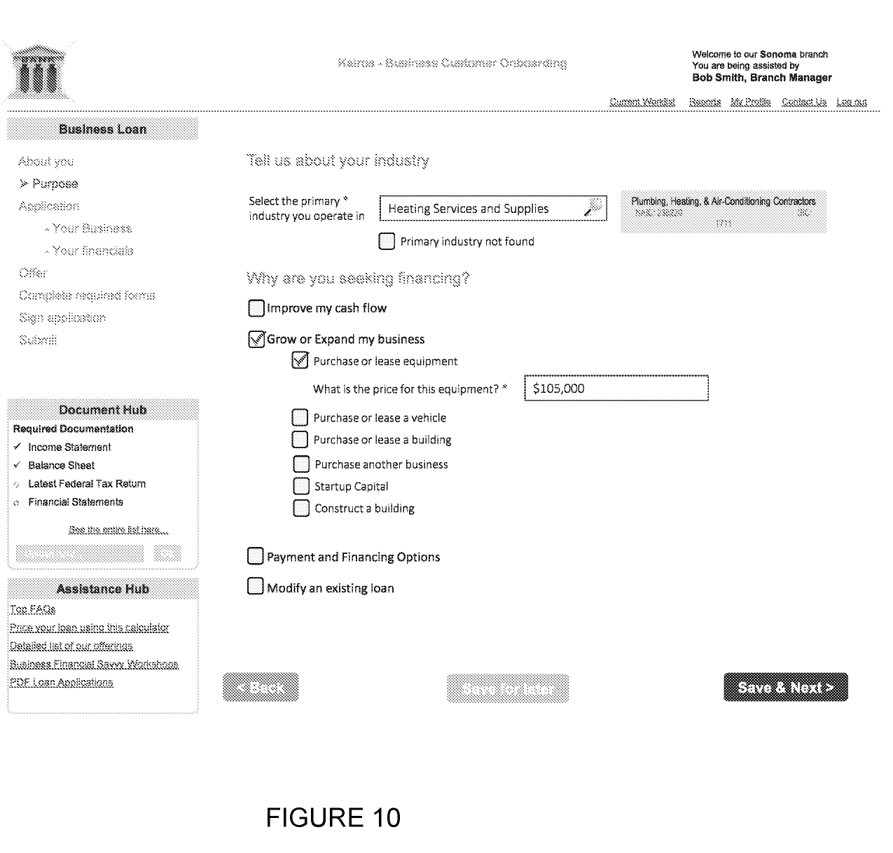

FIG. 8 is an exemplary screenshot of the business customer onboarding application. FIG. 8 shows the customer providing further information about the business, including industry and primary services provided. A search engine may be provided to assist the customer in narrowing down the field of search. The customer may also provide a reasoning behind the need for financing. Non-limiting examples include: Improve my cash flow, grow or expand my business, payment and financing options, and/or modify an existing loan. FIGS. 9 and 10 show examples where the customer may provide further information behind the possible reasoning behind the need for financing.

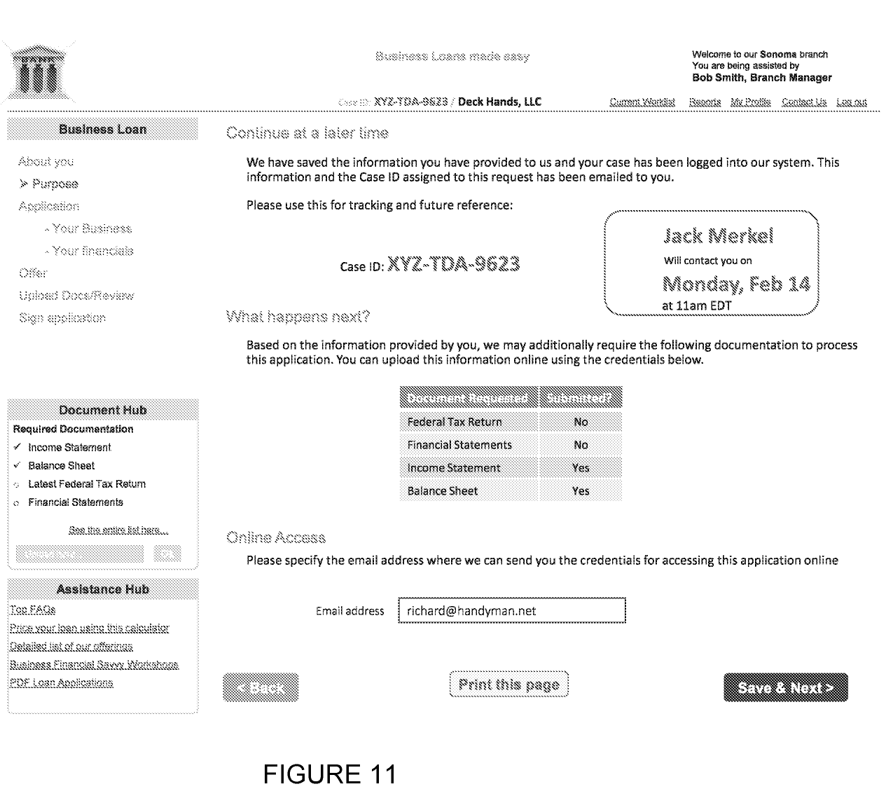

FIG. 11 is an exemplary screenshot of another step of the application process. In FIG. 11, if the customer has decided to save the application for later, the customer may be shown a confirmation page that the application has been saved and may include, but is not limited to, follow-up information, case ID number, and future documentation needed for later to complete the application. Further, the customer may be given the option to print a hard copy of the confirmation page.

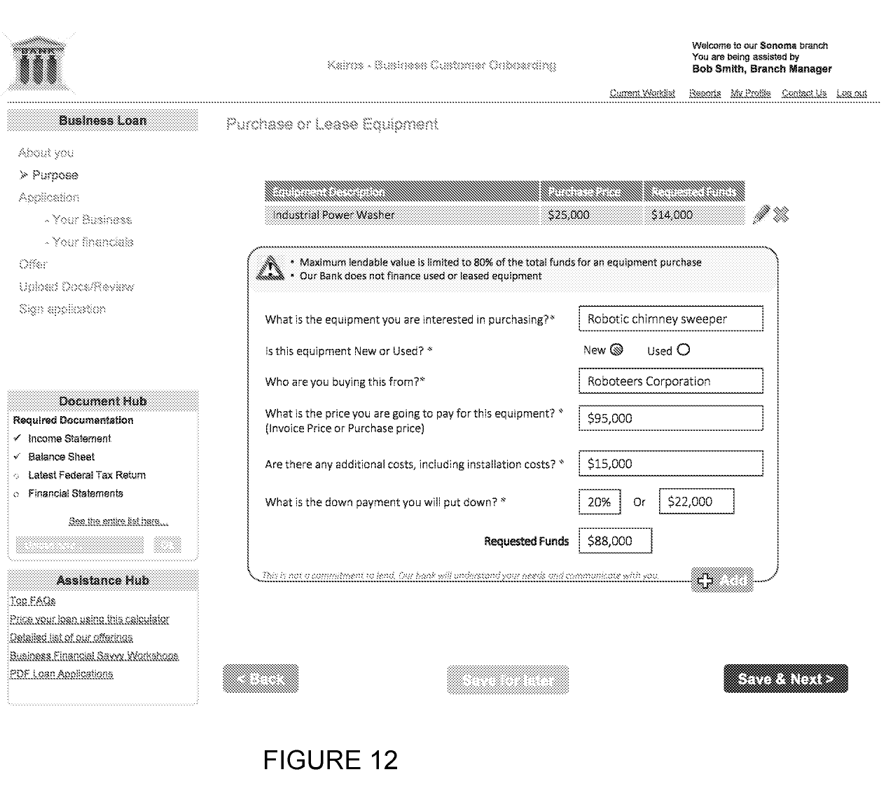

FIG. 12 is an exemplary screenshot of another exemplary step of the application process. In this step, the customer may provide specific details behind the purpose of the loan. The customer may provide specific details behind the purchase of a certain item. In this example, the customer provides specific details including equipment name, new or used, purchase price, installation price, and down payment amount. The specific details shown in FIG. 12 are for exemplary purposes only and are not considered limiting.

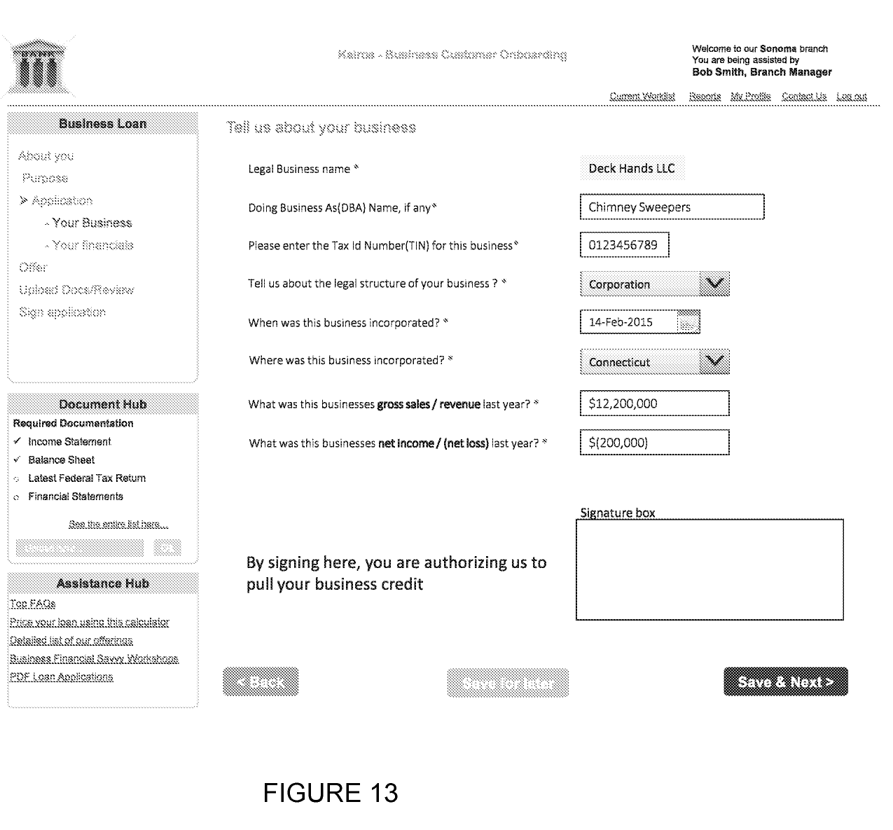

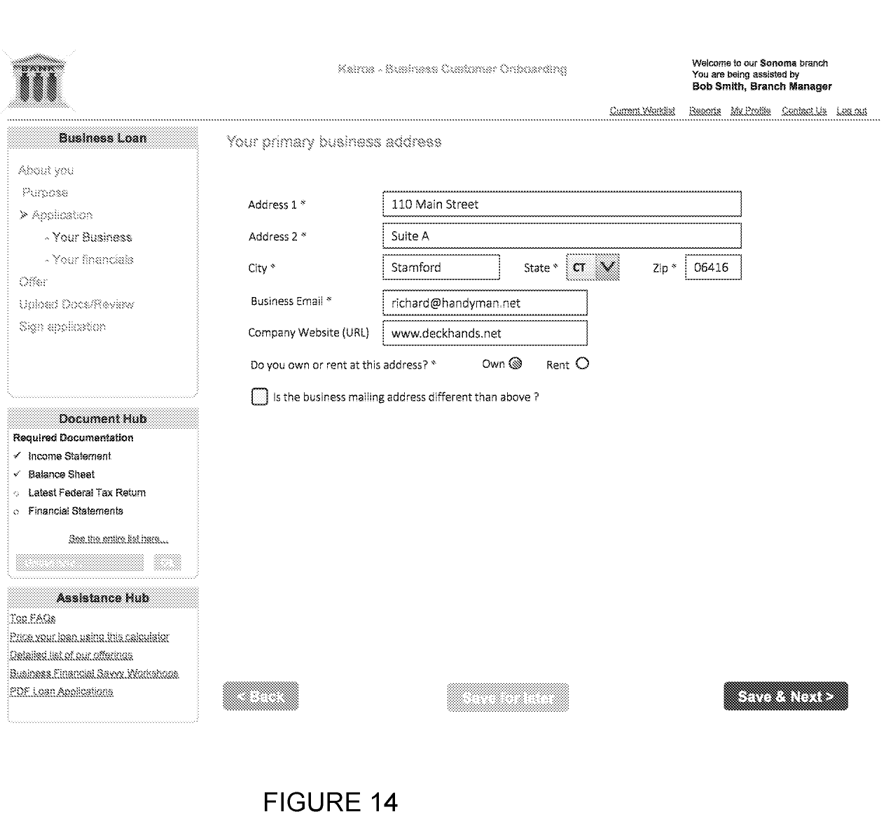

FIGS. 13 and 14 are exemplary screenshots of further steps of the application process. In this exemplary application page, the customer provides details of the actual business. For example, the customer may provide the DBA (“Doing Business As”) name, legal structure, gross/net income, etc. The customer may also provide their signature via an online signature box. FIG. 14 provides appropriate fields for the customer to provide address information.

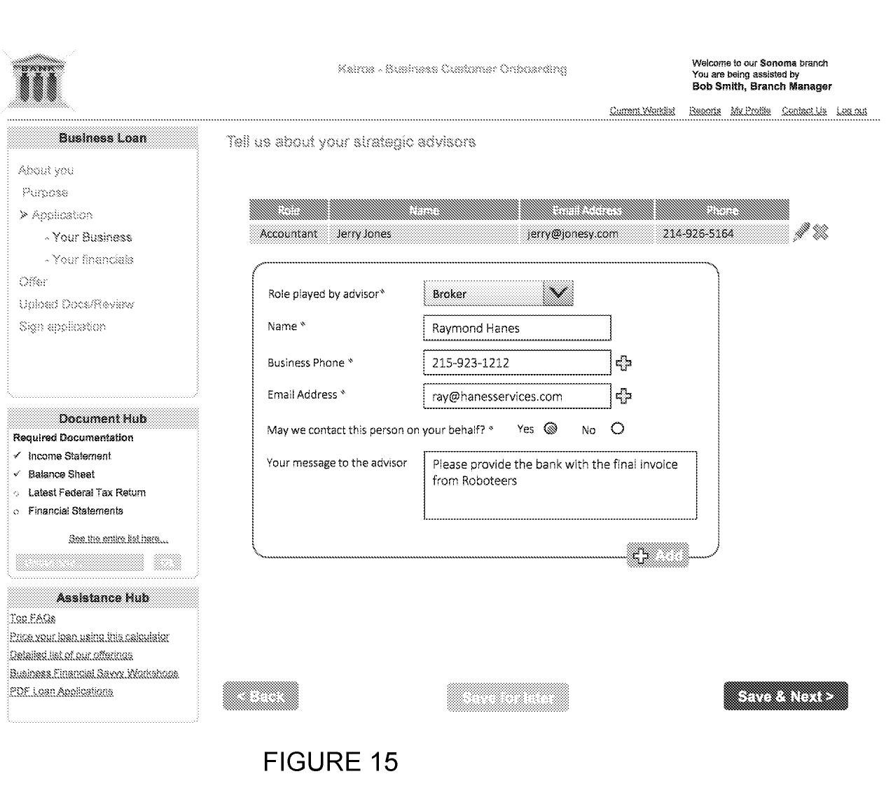

FIG. 15 is an exemplary screenshot of another step of the application process. In this example, the customer may provide information about the customer's team of strategic advisors. The strategic advisors may then be enabled to provide further information to the onboarding process to assist in the loan process.

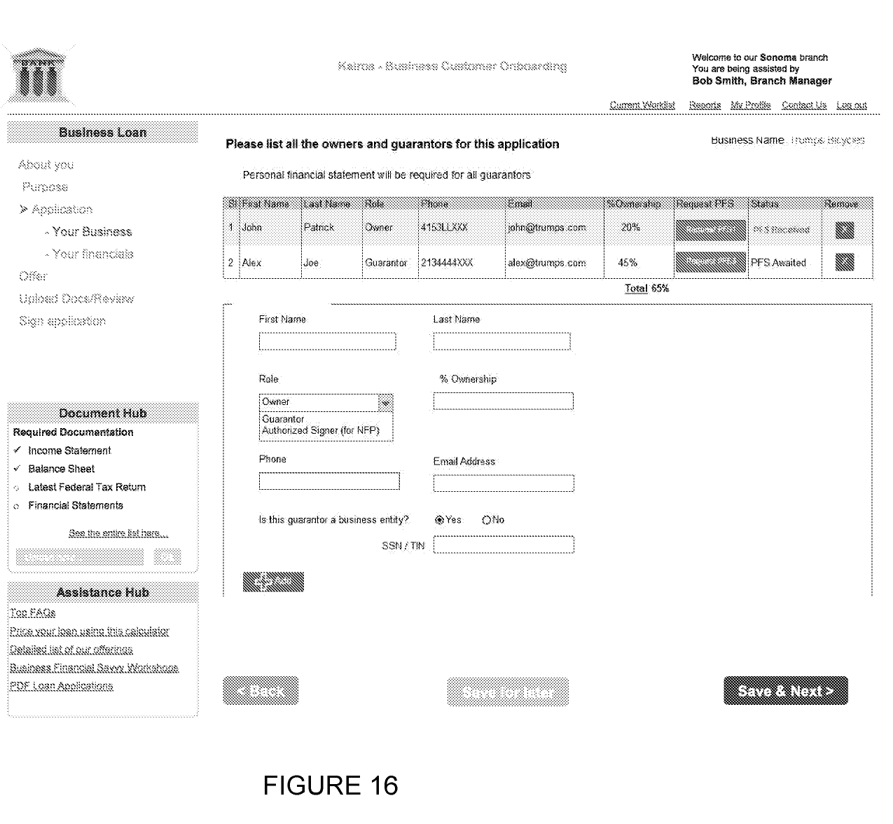

FIG. 16 is an exemplary screenshot of another step of the application process. In this example, the customer may provide the details of all the owners and/or guarantors of the loan being applied for.

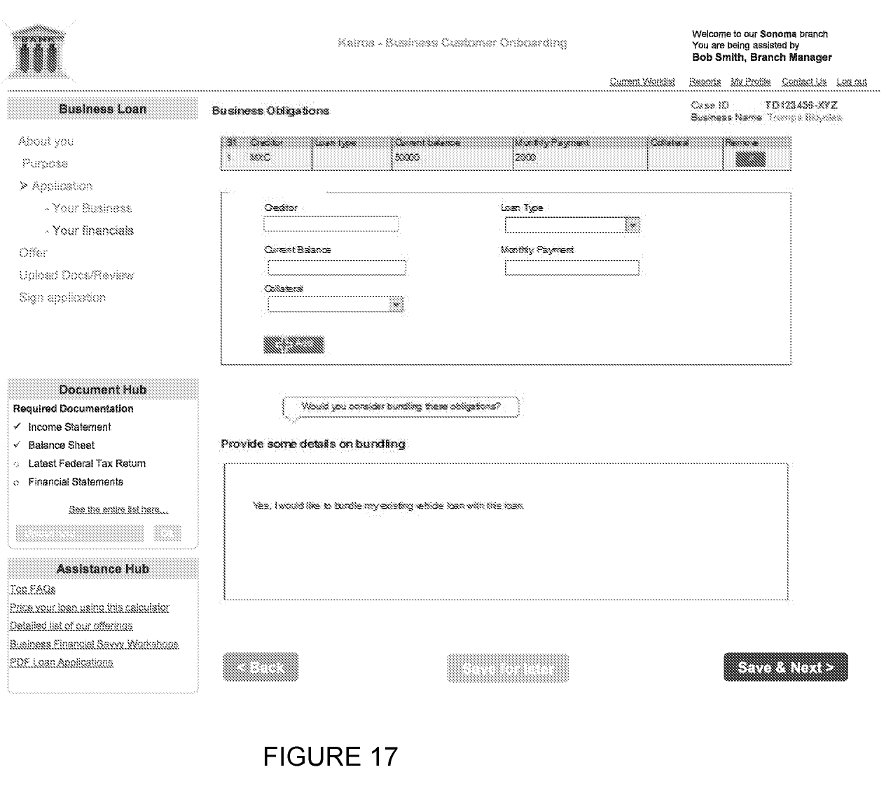

FIG. 17 is an exemplary screenshot of another step of the application process. In this example, the customer may provide information behind business obligations and further information on possibly bundling the business obligations.

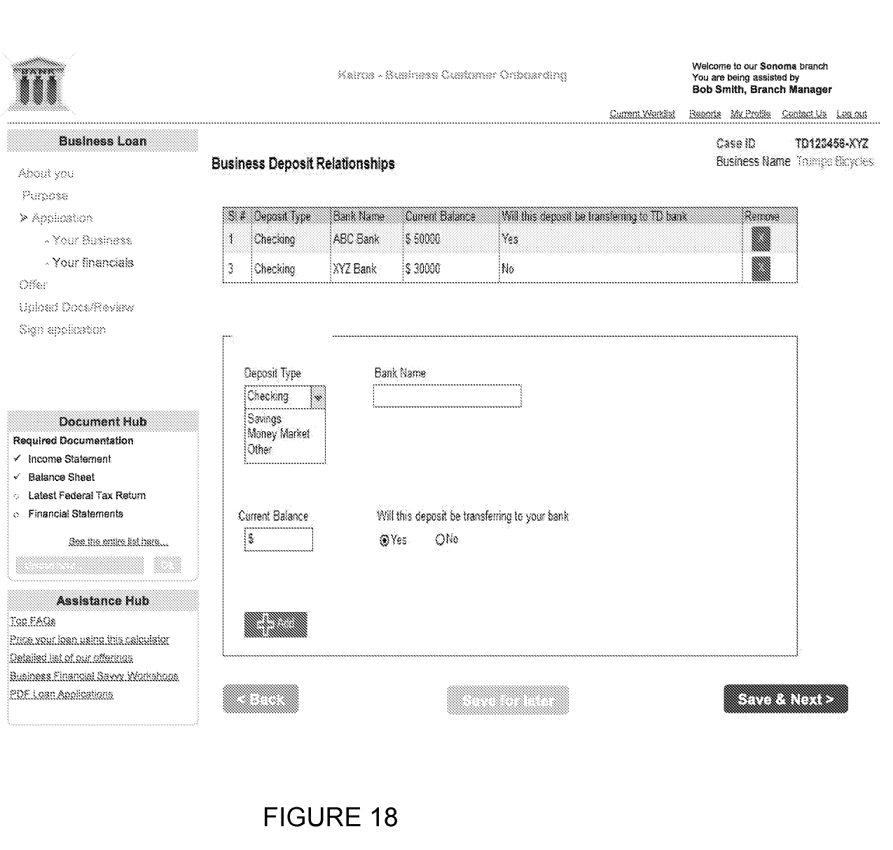

FIG. 18 is an exemplary screenshot of another step of the application process. In this example, the customer may provide business deposit information. For example, deposit accounts (checking, savings, money market, etc.), bank institution name, current balances, etc.

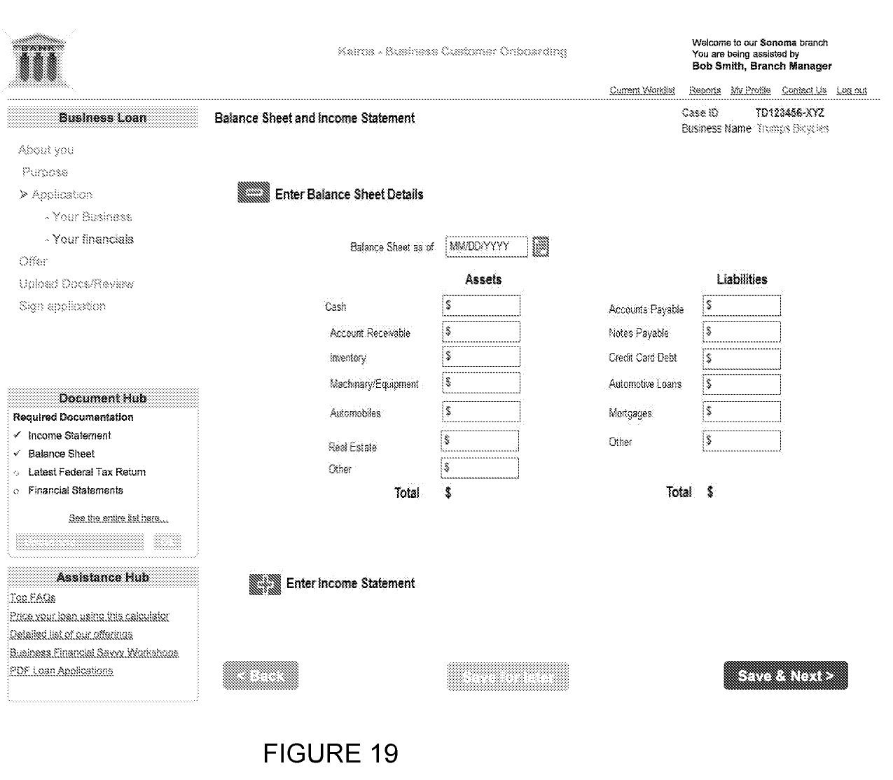

FIG. 19 is an exemplary screenshot of another step of the application process. In this example, the customer may provide balance sheet details. The balance sheet details includes, but is not limited to, assets (cash, account receivable, inventory, machinery/equipment, automobiles, real estate) and liabilities (accounts payable, notes payable, credit card debt, auto loans, and/or mortgages). Balance sheet may also include an income statement.

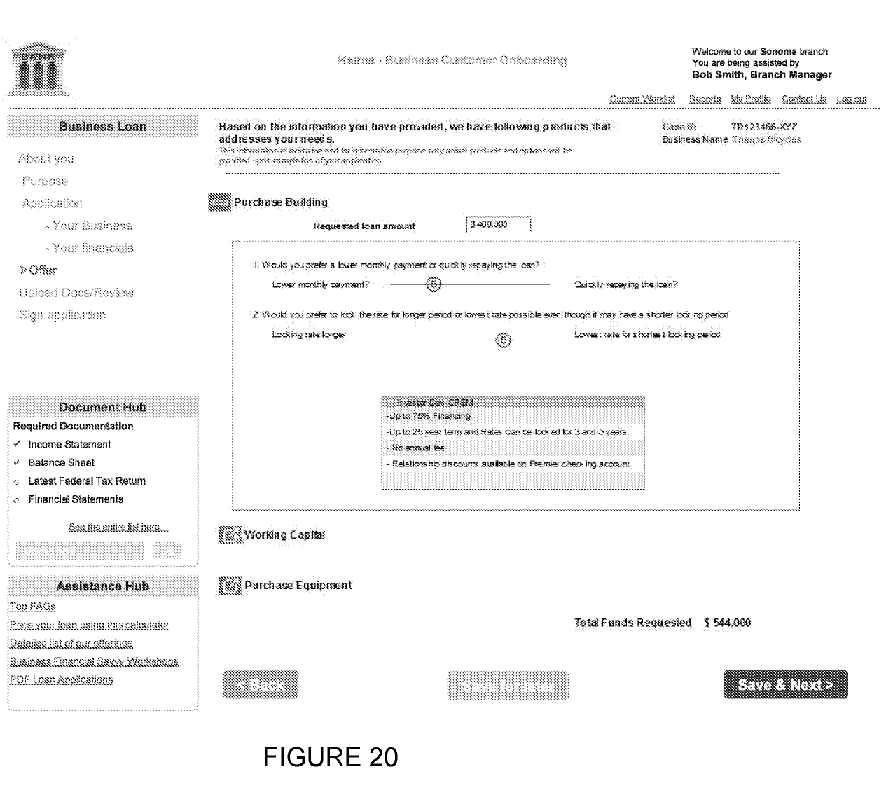

FIG. 20 is an exemplary screenshot of another step of the application process. In this example, the customer may provide building purchase details. The customer may be provided a sliding scale between lower monthly payments and quickly repaying loan options.

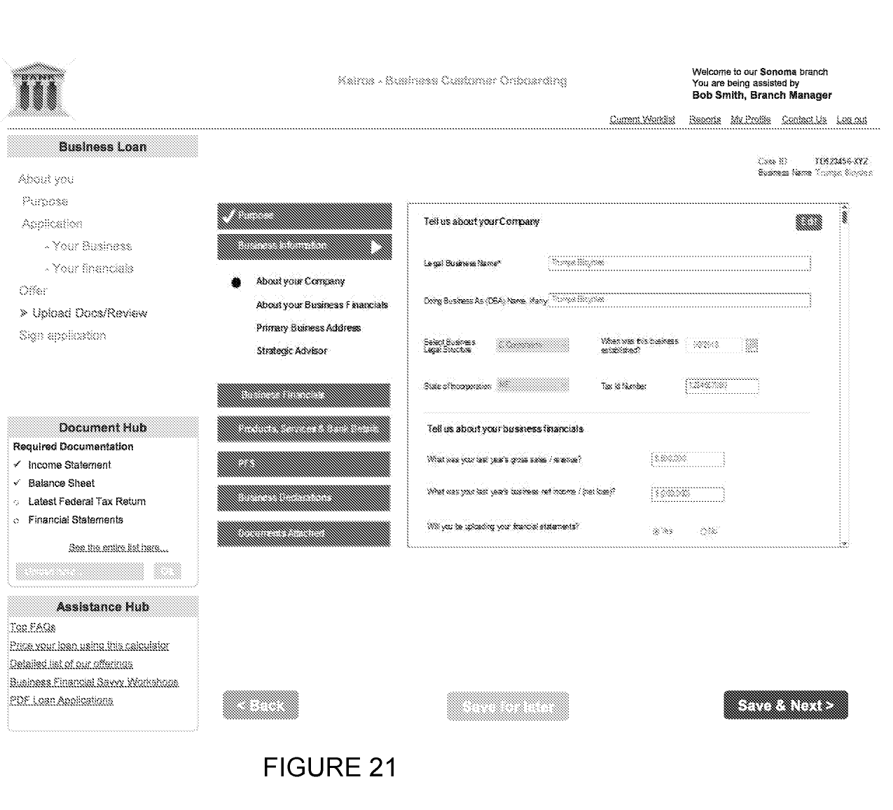

FIG. 21 is an exemplary screenshot of another step of the application process. In this example, the business customer may provide further company details including, but not limited to, company name, DBA name, business legal structure, establishment date, state of incorporation, tax ID number, and business financials. The business financials may include, but is not limited to, last year's gross sales/revenue, last year's net income/net loss, and also the option to upload financial statements. Financial statements may be uploaded via a scan or a PDF, for example.

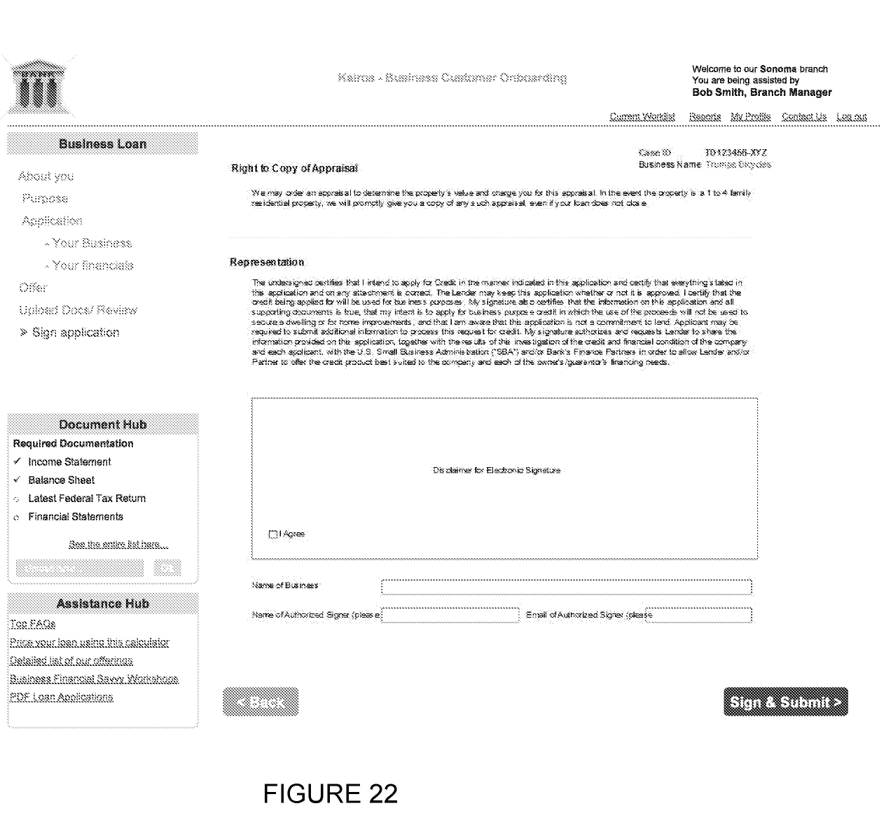

FIG. 22 is an exemplary screenshot of a final step of the application process. The business customer may be provided with appropriate windows to provide an electronic signature, name of business, the name of the authorized signer, and an electronic mail address of the authorized signer. Other appropriate boxes may be provided to have the business customer to provide further information, such as a phone number or the like.

### EXAMPLES

In one embodiment, a method for performing business customer onboarding is disclosed. The method may comprise identifying one or more needs of a business customer, matching one or more business experts and non-business experts with said customer based on the identified one or more needs, displaying a non-sequential series of windows to request information related to said customer, wherein said information is used to create at least one application to fulfill said need and said requested information is also based on said matched expert, and verifying said at least one application. The method may further comprise wherein said information is used to create a second application to fulfill a second of the one or more needs. The method may further comprise offering non-bank related transactions. The method may further comprise prompting for a digital signature. The method may further comprise offering potential needs different from said identified need based on an omni-channel lead capture associated with the business customer. The method may further comprise offering services from a bank unaffiliated with said expert. The method may further comprise wherein the application is saved by the business customer and continued at a later time. The method may further comprise wherein each window to be displayed is determined by information collected in either the immediately preceding displayed window, a previously displayed one or more windows, or a combination thereof and wherein content of the non-sequential series of windows to request information is displayed in a language customized by the business customer. The method may further comprise wherein the application is completed by a person associated with the business customer. The method may further comprise wherein the person is a financial advisor.

This disclosure is to be considered as exemplary and not restrictive in character, and all changes and modifications that come within the spirit of the disclosure are desired to be protected.

1. A method for performing business customer onboarding, with at least one computing device, the method comprising:
identifying one or more needs of a business customer;
matching one or more business experts and non-business experts with said customer based on the identified one or more needs;
displaying a non-sequential series of windows to request information related to said customer, wherein said information is used to create at least one application to fulfill said need and said requested information is also based on said matched expert; and
verifying said at least one application.

2. The method of claim 1, wherein said information is used to create a second application to fulfill a second of the one or more needs.

3. The method of claim 1, further comprising:
offering non-bank related transactions.

4. The method of claim 1, further comprising:
prompting for a digital signature.

5. The method of claim 1, further comprising:
offering potential needs different from said identified need based on an omni-channel lead capture associated with the business customer.

6. The method of claim 1, further comprising:
offering services from a bank unaffiliated with said expert.

7. The method of claim 1 wherein the application is saved by the business customer and continued at a later time.

8. The method of claim 1, wherein each window to be displayed is determined by information collected in either the immediately preceding displayed window, a previously displayed one or more windows, or a combination thereof; and
wherein content of the non-sequential series of windows to request information is displayed in a language customized by the business customer.

9. The method of claim 1, wherein the application is completed by a person associated with the business customer.

10. The method of claim 9, wherein the person is a financial advisor.

11. A non-transitory computer readable medium comprising instructions for performing business customer onboarding, the instructions when executed by at least one hardware processor implement the method of:
identifying one or more needs of a business customer;
matching one or more business experts and non-business experts with said customer based on the identified one or more needs;
displaying a non-sequential series of windows to request information related to said customer, wherein said information is used to create at least one application to fulfill said need and said request information is also based on said assessing; and
verifying said at least one application.

12. The medium of claim 11, wherein said information is used to create a second application to fulfill a second of the one or more needs.

13. The medium of claim 11, the instructions further implement:
offering non-bank related transactions.

14. The medium of claim 11, the instructions further implement:
prompting for a digital signature.

15. The medium of claim 11, the instructions further implement:
offering potential needs different from said identified need based on an omni-channel lead capture associated with the business customer.

16. The medium of claim 11, the instructions further implement:
offering services from a bank unaffiliated with said expert.

17. The medium of claim 11 wherein the application is saved by the business customer and continued at a later time.

18. The medium of claim 11, wherein each window to be displayed is determined by information collected in either the immediately preceding displayed window, a previously displayed one or more windows, or a combination thereof; and
wherein content of the non-sequential series of windows to request information is displayed in a language customized by the business customer.

19. The medium of claim 11, wherein the application is completed by a person associated with the business customer.

20. The medium of claim 19, wherein the person is a financial advisor.
